(19) United States
(12) Patent Application Publication
(10) Pub. No.: US 2016/0373037 A1
(43) Pub. Date: Dec. 22, 2016

(54) DEVICE FOR CONTROLLING ALTERNATOR AND METHOD FOR CONTROLLING THE SAME

(71) Applicant: HYUNDAI MOTOR COMPANY, Seoul (KR)

(72) Inventor: Byung Hwan JUNG, Gyeonggi-do (KR)

(21) Appl. No.: 14/885,819

(22) Filed: Oct. 16, 2015

(30) Foreign Application Priority Data
Jun. 16, 2015 (KR) 10-2015-0084915

(51) Int. Cl. H02P 9/00

(52) U.S. Cl. CPC H02P 9/00

(57) ABSTRACT

A device and a method for controlling an alternator which is connected to an engine through a pulley and an accessory belt include a drive motor connected to a rotor shaft of the alternator. A controller is configured to control the drive motor so that a rotation cycle of the rotor shaft has the same phase as a rotation cycle of a crankshaft of the engine.

### CROSS-REFERENCE TO RELATED APPLICATION

This application claims the benefit of priority to Korean Patent Application No. 10-2015-0084915 filed in the Korean Intellectual Property Office on Jun. 16, 2015, the entire content of which is incorporated herein by reference.

### TECHNICAL FIELD

The present disclosure is a device for controlling an alternator and a method for controlling the same.

### BACKGROUND

A crankshaft in an internal combustion engine rotates at constant fluctuation. When there is instantaneous rotation fluctuation of the crankshaft, belt slip occurs due to an instantaneous driving load in an accessory pulley of an engine front end accessory drive (FEAD) belt system or an accessory drive belt system.

Noise and abrasion at the accessory drive belt system occur due to the slip of the pulley and the belt, and vibration of the FEAD belt system is generated by an excitation force of a periodic ascending or descending in a length direction of the belt.

The accessory drive belt system has an alternator which includes an alternator rotor having a large inertial force and a small pulley, and accordingly, a driving load generated is relatively large due to the instantaneous rotation fluctuation of the crankshaft.

Therefore, the slip of the belt is generated in the pulley of the alternator, and thus, a pulley having a special function is required such as an overrunning alternator pulley (OAP) and an overrunning alternator decoupler (OAD) to improve durability and noise of the accessory drive belt system.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a device for controlling an alternator capable of reducing a load of the accessory belt without using a pulley having a special function, and a method for controlling the same.

According to an exemplary embodiment of the present inventive concept, a device for controlling an alternator, in which the alternator is connected to an engine through a pulley and an accessory belt, includes a drive motor connected to a rotor shaft of the alternator. A controller is configured to control the drive motor so that a rotation cycle of the rotor shaft has the same phase as a rotation cycle of a crankshaft of the engine.

The drive motor may increase a speed of the rotor shaft of the alternator when a rotational speed of the crankshaft increases.

The drive motor may decrease the speed of the rotor shaft of the alternator when the rotational speed of the crankshaft decreases.

The controller may control a driving direction of the drive motor using a rotation signal of the crankshaft or a camshaft, which is detected from the engine by an electronic control unit (ECU).

The controller may control a driving direction of the drive motor using a signal of a spark plug or a fuel injector.

According to another exemplary embodiment of the present inventive concept, a method for controlling an alternator includes detecting a rotation cycle of a crankshaft of an engine. A driving direction of a drive motor, which is connected to a rotor shaft of the alternator, is controlled using the detected rotation cycle. A rotor of the alternator is driven by a rotation cycle having the same phase as the rotation cycle of the crankshaft using the drive motor.

The step of controlling the driving direction may include controlling the driving direction of the drive motor using a rotation signal of the crankshaft or a camshaft, which is detected from the engine by an ECU.

The step of controlling the driving direction may include controlling the driving direction of the drive motor using a signal of a spark plug or a fuel injector.

The step of driving the rotor of the alternator may include driving the drive motor to increase a speed of the rotor shaft of the alternator when a rotational speed of the crankshaft increases.

The step of driving the rotor of the alternator may include driving the drive motor to decrease the speed of the rotor shaft of the alternator when the rotational speed of the crankshaft decreases.

According to the present disclosure, a rotation torque component applied to the alternator rotor is removed, and as a result, it is possible to reduce a load of the accessory belt and improve a slip and an abrasion at the pulley of the alternator.

### BRIEF DESCRIPTION OF THE DRAWINGS

FIG. 1 is a schematic diagram of a device for controlling an alternator according to an exemplary embodiment of the present inventive concept.

FIG. 2 is a schematic diagram of a device for controlling an alternator according to another exemplary embodiment of the present inventive concept.

FIG. 3 is a diagram showing a rotational vibration of a crankshaft of an engine.

FIG. 4 is a diagram showing a rotational vibration of an alternator pulley in FIG. 3.

FIG. 5 is a flowchart briefly showing a process of controlling rotation of an alternator by a device for controlling the alternator according to an exemplary embodiment of the present inventive concept.

FIG. 6 is a diagram showing a speed increasing interval and a speed decreasing interval according to a rotation of a crankshaft of an engine.

### DETAILED DESCRIPTION OF THE EMBODIMENTS

In the following detailed description, only certain exemplary embodiments of the present inventive concept have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

In addition, the terms “-er”, “-or” and “module” described in the specification mean units for processing at least one function and operation and can be implemented by hardware components or software components and combinations thereof.

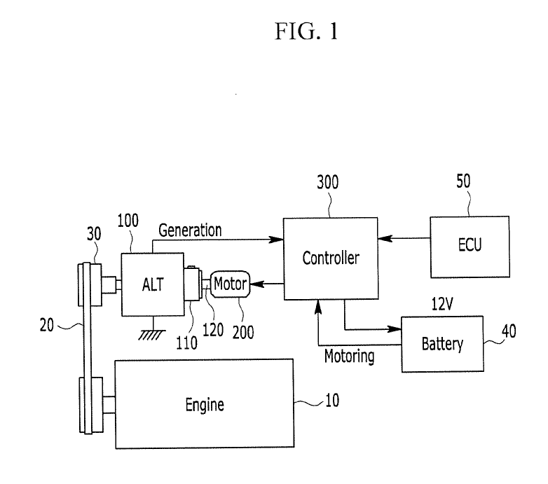

Hereinafter, a device for controlling an alternator and method for controlling the same according to an exemplary embodiment of the present inventive concept will be described in detail reference to FIG. 1 to FIG. 5.

FIG. 1 is a schematic diagram of a device for controlling an alternator to an exemplary embodiment of the present inventive concept. In this case, the device for controlling the alternator describes only a schematic configuration necessary for description according to an exemplary embodiment of the present inventive concept, and is not limited to such a configuration.

Referring to FIG. 1, a device for controlling an alternator according to an exemplary embodiment of the present inventive concept includes an alternator 100, a drive motor 200, and a controller 300.

The alternator 100, which is connected to an engine 10 through a pulley 30 and an accessory belt 20, includes a rotor (not shown) and a stator (not shown). The alternator 100 is concentrically connected with a resolver 110 and the drive motor 200 through a rotor shaft 120.

In one exemplary embodiment, the drive motor 200 is mounted to an exterior of the alternator 100, and is connected to the rotor shaft 120 of the alternator 100. In another exemplary embodiment, the drive motor 200 may be disposed inside the alternator 100.

The controller 300 controls electrical energy generated from the alternator 100 to store into a battery 40 of a vehicle, and drives the drive motor 200 by using power of the battery 40.

The controller 300 controls the drive motor 200 for applying a rotation cycle with the same phase as a rotation cycle of a crankshaft (not shown) of the engine 10 to the rotor of the alternator 100.

The drive motor 200 is driven to increase a speed of the rotor shaft 120 of the alternator 100 when a rotational speed of the crankshaft increases.

In addition, the drive motor 200 is driven to decrease the speed of the rotor shaft 120 of the alternator 100 when the rotational speed of the crankshaft decreases.

The controller 300 controls a driving direction of the drive motor 200 by using a rotation signal of the crankshaft or a camshaft that is detected from the engine 10 by an electronic control unit (ECU) 50. The controller 300 may control the driving direction of the drive motor 200 by using a signal of a spark plug or a fuel injector (not shown).

The controller 300 controls the rotation cycle of the crankshaft to match with the rotation cycle of the drive motor 200 by using the rotation signal of the crankshaft or the camshaft. In addition, the controller 300 may control the rotation cycle of the crankshaft to match with the rotation cycle of the drive motor 200 by using the signal of the spark plug or the fuel injector

Here, the controller 300 may be implemented with at least one processor operating by a stored predetermined program, and the predetermined program may be programmed to perform each step according to a method for controlling the alternator according to the present disclosure.

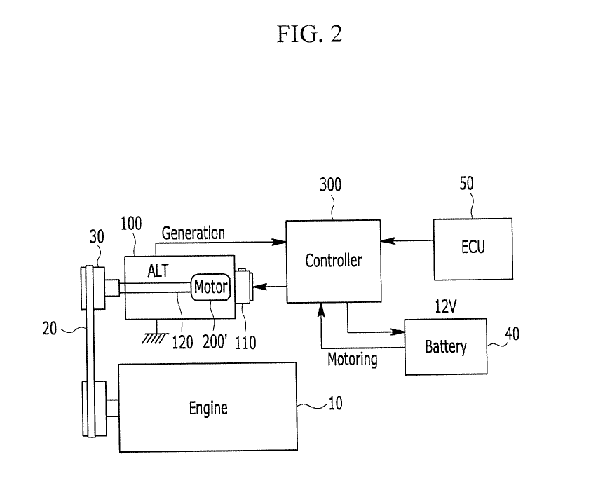

FIG. 2 is a schematic diagram of a device for controlling an alternator according to another exemplary embodiment of the present inventive concept.

Referring to FIG. 2, a device for controlling an alternator according to another exemplary embodiment of the present inventive concept includes a drive motor 200′ that is disposed inside the alternator 100.

In another exemplary embodiment, the drive motor 200′ is disposed inside the alternator 100 and is connected rotor shaft 120 of the alternator 100.

The drive motor 200′ is driven to increase a speed of the rotor shaft 120 of the alternator 100 when a rotational speed of the crankshaft increases, and is driven to decrease the speed of the rotor shaft 120 of the alternator 100 when the rotational speed of the crankshaft decreases.

The controller 300 controls the drive motor 200′ for applying a rotation cycle with the same phase as a rotation cycle of the crankshaft of the engine 10 to the rotor of the alternator 100.

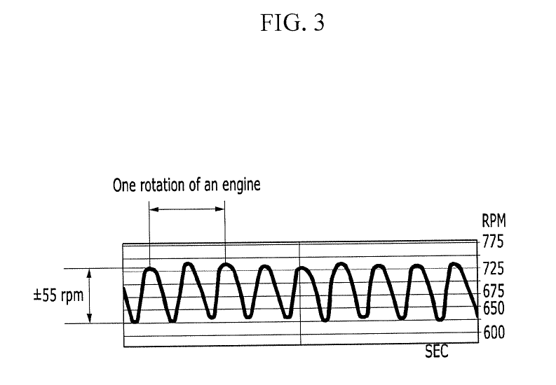

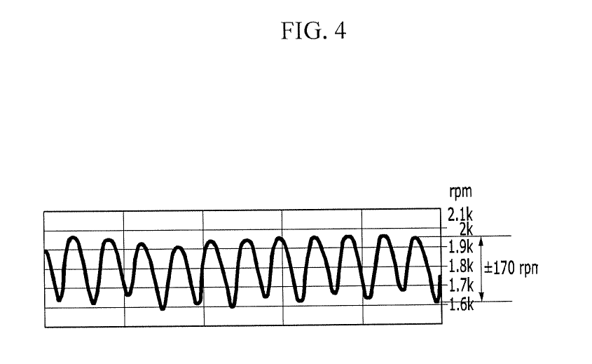

FIG. 3 is a diagram showing a rotational vibration of a crankshaft of an engine, and FIG. 4 is a diagram showing a rotational vibration of an alternator pulley in the FIG. 3.

A crankshaft in an internal combustion engine is unable to rotate at a constant speed since it energy generated by explosion in a cylinder, and the crankshaft rotates at constant fluctuation, as shown in FIG. 3. The fluctuation is variable depending on the number of cylinders, an arrangement method, and an ignition sequence. In general, there are two cycles per one rotation for an in-line 4 cylinder engine.

As shown in FIG. 4, the fluctuation is amplified by changing pulley ratio. Such fluctuation in the pulley 30 the alternator 100 operates as a load of inverse direction to a rotation direction of the accessory belt 20 to drive the alternator 100, and causes a slip and an abrasion of the accessory belt 20.

However, the device for controlling the alternator according to the present disclosure includes the drive motor 200 connected to the alternator 100, and thus, eliminates the load applied to the accessory belt 20 by synchronizing the rotation of the crankshaft of the engine 10 and the rotation of the alternator 100 base on the controlling of the drive motor 200.

Further, the device for controlling the alternator according to the present disclosure is capable of improving the slip and an abrasion at the pulley 30 of the alternator 100 without using a pulley having a special function such as an overrunning alternator pulley (OAP) and an overrunning alternator decoupler (OAD).

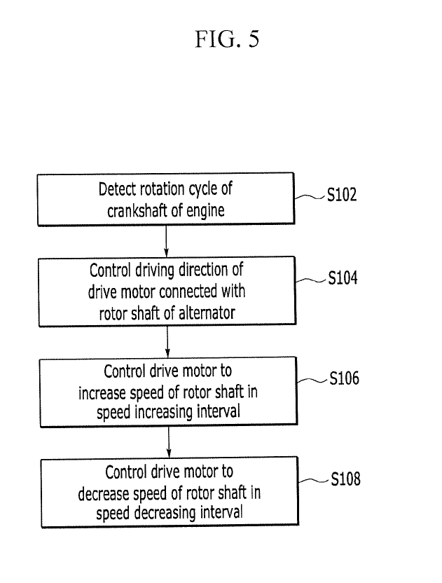

FIG. 5 is a flowchart showing a process of controlling rotation of an alternator by a device for controlling the alternator according to an exemplary embodiment of the present inventive concept. The following flowchart will be described with the same reference numerals as that of a configuration of FIG. 1.

Referring to FIG. 5, the device for controlling of the alternator according to the present disclosure detects a rotation cycle of the crankshaft of the engine 10 at step S102.

In addition, the device controls a driving direction of the drive motor 200 connected with the rotor shaft 120 of the alternator 100 by using the detected to rotation cycle at step S104.

Here, the device controls the driving direction of the drive motor 200 by using a rotation signal of the crankshaft or the camshaft, or controls the driving direction by using a signal of the spark plug or the fuel injector.

The device further controls the driving direction of the drive motor 200 according to an interval by which a rotational speed of the crankshaft increases or decreases.

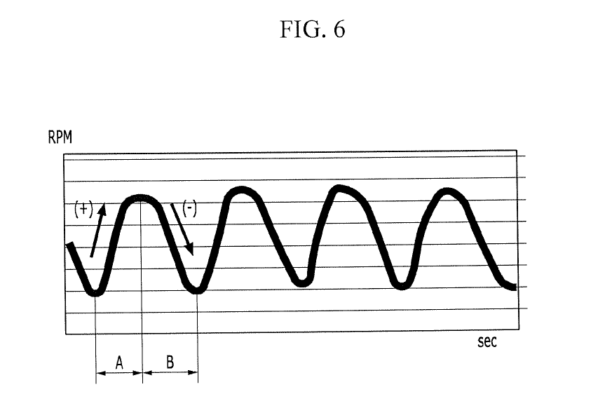

FIG. 6 is a diagram showing a speed increasing interval and a speed decreasing interval according to rotation of a crankshaft of an engine.

The device for controlling of the alternator according to the present disclosure controls the drive motor 200 to increase a speed of the rotor shaft 120 in a speed increasing interval (A) of the crankshaft at step S106. For example, the drive motor 200 is driven to a direction to increase the speed of the alternator 100 when a rotational speed of the crankshaft increases to provide the power required to drive the alternator 100.

The device for controlling of the alternator according to the present disclosure controls the drive motor 200 to decrease the speed of the rotor shaft 120 in a speed decreasing interval (B) of the crankshaft at step S108. For example, the drive motor 200 is driven in a direction to decrease the speed of the alternator when a rotation speed of the crankshaft decreases to suppress a torque of the alternator rotor by inertia.

Therefore, in the related art, an inertia load of the alternator rotor is generated in the speed increasing interval, and a speed of the pulley 30 becomes smaller than a speed of the accessory belt 20, and the accessory belt 20 is tensioned.

When the inertia load of the alternator rotor is generated in the speed increasing interval (A), the device for controlling the alternator according to the present disclosure generates a load in a forward direction, and offsets the inertia load by a driving torque of the drive motor 200, and as a result, a load of the accessory belt 20 decreases.

In the related art, an inertia torque of the alternator rotor is generated in the speed decreasing interval, and the speed of the pulley 30 becomes greater than the speed of the accessory belt 20, and the accessory belt 20 is contracted.

However, when the inertia torque of the alternator rotor is generated in the speed decreasing interval (B), the device for controlling the alternator according to the present disclosure generates a load in the reverse direction of the drive motor 200, and offsets an inertia moment of the alternator rotor by the load, and as a result, the load of the accessory belt 20 decreases.

As described above, in the device for controlling the alternator according to the present disclosure, by applying a rotation component having the same phase as a rotation component of the crankshaft to the alternator rotor using the drive motor and eliminating a rotation torque component, load of the accessory belt is reduced and slip and abrasion occurring at the pulley of the alternator is improved.

The exemplary embodiment of the present inventive concept described above is implemented by not only an apparatus and a method but also a program realizing a function corresponding to a configuration of the exemplary embodiment of the present inventive concept or a recording medium recording the program.

While this invention has been described in connection with what is presently considered to be practical exemplary embodiments, it is to be understood that the invention is not limited to the disclosed embodiments, but is on the contrary, is intended to cover various modifications and equivalent arrangements included within the spirit and scope of the appended claims.

What is claimed is:

1. A device for controlling an alternator, in which the alternator is connected to an engine through a pulley and an accessory belt, the device comprising:
a drive motor connected to a rotor shaft of the alternator; and
a controller configured to control the drive motor so that a rotation cycle of the rotor shaft has the same phase as a rotation cycle of a crankshaft of the engine.

2. The device of claim 1, wherein
the drive motor is operative to increase a speed of the rotor shaft of the alternator when a rotational speed of the crankshaft increases.

3. The device of claim 2, wherein
the drive motor is operative to decrease the speed of the rotor shaft of the alternator when the rotational speed of the crankshaft decreases.

4. The device of claim 3, wherein
the controller is configured to control a driving direction of the drive motor using a rotation signal of the crankshaft or a camshaft, which is detected from the engine by an electronic control unit (ECU).

5. The device of claim 3, wherein
the controller is configured to control a driving direction of the drive motor using a signal of a spark plug or a fuel injector of the engine.

6. The device of claim 1, wherein the alternator is concentrically connected with a resolver and the drive motor through the rotor shaft.6. A method for controlling an alternator, the method comprising:
detecting a rotation cycle of a crankshaft of an engine;
controlling a driving direction of a drive motor connected to a rotor shaft of the alternator using the detected rotation cycle; and
driving a rotor of the alternator by a rotation cycle having the same phase as the rotation cycle of the crankshaft using the drive motor.

7. The method of claim 6, wherein
the step of controlling the driving direction includes:
controlling the driving direction of the drive motor using a rotation signal of the crankshaft or a camshaft, which is detected from the engine by an electronic control unit (ECU).

8. The method of claim 6, wherein
the step of controlling the driving direction includes:
controlling the driving direction of the drive motor using a signal of a spark plug or a fuel injector.

9. The method of claim 6, wherein
the step of driving the rotor of the alternator includes:
driving the drive motor to increase a speed of the rotor shaft of the alternator when a rotational speed of the crankshaft increases.

10. The method of claim 9, wherein
the step of driving the rotor of the alternator includes:
driving the drive motor to decrease the speed of the rotor shaft of the alternator when the rotational speed of the crankshaft decreases.

11. A non-transitory computer-readable recording medium comprising computer executable instructions execution of which causes a controller to perform the method of claim 6.
